(19) United States
(12) Patent Application Publication
(10) Pub. No.: US 2025/0319757 A1
(43) Pub. Date: Oct. 16, 2025

(54) CAR COVER

(71) Applicant: Wayne Siltanen, Los Angeles, CA (US)

(72) Inventor: Wayne Siltanen, Los Angeles, CA (US)

(21) Appl. No.: 19/175,347

(22) Filed: Apr. 10, 2025

Related U.S. Application Data
(60) Provisional application No. 63/632,503, filed on Apr. 10, 2024.

(51) Int. Cl. B60J 11/04

(52) U.S. Cl. CPC B60J 11/04

(57) ABSTRACT

A car cover includes a cover material configured to conformally fit over a vehicle. A clear window is integrally formed within the cover to be disposed over a video camera of the vehicle allowing the video camera to view through the at least one clear window when the car cover is disposed overtop vehicle. A zipper opens starting from a bottom and extends to a top to allow a door to be opened without removing the car cover. An additional strip of protective material may be disposed on the inside of the zipper. A breathable mesh is integrally formed in the cover car and disposed adjacent to a vent of the vehicle. A charging port access is integrally formed in the car cover and disposed abutting a charging port of the vehicle. The charging port access is an openable flap formed in the cover material with a reflective material.

### CROSS-REFERENCE TO RELATED APPLICATIONS

This application claims priority to U.S. provisional application 63/632,503 filed on Apr. 10, 2024, the entire contents of which are hereby incorporated in full by this reference.

### DESCRIPTION

### Field of the Invention

The present invention generally relates to car covers. More particularly, the present invention relates to an improved car cover for electric cars.

### Background of the Invention

A traditional car cover, designed primarily for internal combustion engine (ICE) vehicles, may not work effectively for electric vehicles (EV) due to key differences in design, functionality, and requirements. One of the biggest issues is charging access. Since EVs require frequent charging while parked, a conventional cover may lack openings for a charging cable, forcing users to either leave part of the cover off or remove it entirely. If the cover is draped over the car during charging, it could put strain on the charging port or obstruct necessary airflow for cooling the charging components.

Additionally, many EVs have battery thermal management systems that regulate temperature, even when parked. A traditional car cover may trap heat or block ventilation, leading to inefficiencies or potential overheating. This is particularly problematic in extreme climates, where an EV's cooling or heating system must function properly to preserve battery health. Compounding this issue is the fact that EVs frequently receive over-the-air (OTA) software updates, which can activate components such as lights, sensors, or cooling fans unexpectedly. A standard cover may interfere with these functions, potentially obstructing cameras and sensors or restricting airflow.

The aerodynamic design of many EVs also presents a challenge. Traditional covers may not fit properly over vehicles with sloped roofs, lack of front grilles, or flush door handles, leading to excess fabric that flaps in the wind and could scratch the surface. Sensor interference is another major problem, as EVs rely heavily on cameras, radar, and LiDAR for driver assistance systems, autopilot features, and security functions like Tesla's® Sentry Mode. A regular cover may block or interfere with these sensors, rendering them ineffective or causing unintended battery drain if security systems are triggered by movement under the cover.

Heat retention is another concern, as EV batteries are particularly sensitive to temperature fluctuations. A traditional cover made of non-breathable materials could contribute to excessive heat buildup in summer or fail to provide adequate insulation in winter. Since some EVs have cooling fans and heat pumps that operate even when the vehicle is off, a poorly ventilated cover might restrict airflow and cause inefficiencies. Additionally, electronic door mechanisms and auto-presenting handles, such as those found on Tesla@ and Rivian® models, may be obstructed by a conventional cover, potentially draining the battery or making it difficult to access the vehicle.

Other stationary features could also be impacted by a traditional cover. Some EVs continue using various vehicle components while parked to maintain charge levels, and if airflow around the wheels is restricted, it may affect this function. Certain EVs offer features like “camp mode” or “dog mode,” which maintain climate control when parked, and a conventional cover may interfere with ventilation, reducing efficiency. In some cases, keyless entry proximity sensors could also be confused if the cover moves or presses against the vehicle.

Ultimately, a traditional car cover does not account for the unique needs of an electric vehicle, making it less effective and, in some cases, even problematic. A well-designed EV-specific cover should include dedicated flaps for charging port access, breathable yet insulated materials to regulate temperature, sensor-friendly sections to accommodate various features, and a tailored fit for modern EV aerodynamics. Additionally, UV-reflective and heat-resistant materials can help mitigate temperature concerns, ensuring the vehicle remains protected while maintaining its operational efficiency.

Accordingly, there is a need for an improved car cover for electric vehicles. The present invention fulfills these needs and provides other related advantages.

### SUMMARY OF THE INVENTION

FIGS. 1-12 of the provisional application 63/632,503 filed on Apr. 10, 2024 illustrate and describe an improved car cover for cars with advanced features configured for electric vehicles, as the provisional application incorporated in full the information disclosed in the figures and associated text. In furtherance of the information in FIGS. 1-12, more detail is added herein below.

The improved car cover includes various clear portions configured to allow the electric vehicle's cameras to view through while the car cover is deployed about the vehicle. It is contemplated that the clear portions of the car cover should not be glass due to its fragile nature and rather it is preferred to lean towards using plastic/acrylic material and coat the outside and/or inside of it with a protective ceramic coating. Since 2022, all new Tesla's® being manufactured have stopped building vehicles with ultrasonic sensors (USS). The shift toward camera-only ‘Tesla® Vision’ driver-assist tech is their new standard, hence the importance of this type of product. Tesla's® decision to move in this direction contrasts with the rest of the industry's reliance on a mix of LIDAR, radar, and cameras. In short, they believe computer vision is what will advent the autonomy of their entire fleet and this car cover is designed to facilitate the use of such computer vision even while the car cover is deployed about the car.

Various locations on the car cover can include clear portions. For example, a clear portion could be located at the top center of the front windshield as this is a common location where car manufacturers place advanced technology video cameras. A clear portion could be placed at the side of the car cover about the rearward looking side cameras that are in front of the front doors but behind the front wheel arch. These cameras look along the side of the car and into the traditional blind spot of the driver. A clear portion could be placed around the location for the rear camera that may be placed along the rear windshield or along the rear bumper area, such as around the license plate. Additionally, a clear portion could be placed about the front or rear license plates. As can be understood by those skilled in the art, there are many locations where a clear portion could be integrated into the car cover of the present invention.

All, or at least many, of the portions of the cameras are located on glass windows and/or pillars or rear and/or front camera mounts. It is possible to use a simple suction cup mechanism to make sure the clear portions of the car cover remain disposed over the camera's viewpoints. This could mean one or a plurality of suction cups could be used to secure the clear portions in place.

Alternatively, specially designed fastening means with adhesive backing could be strategically attached to various glass and/or vehicle body surfaces that could provide a more reliable attachment point in comparison to a suction cup. For example, a fastening means could be a hook-and-loop type fastener where one side is adhered to the electric vehicle and the other side is integrally formed into the cover. As a second example, the fastening means could be a snap button with one side attached to the electric vehicle and the other side attached to the cover.

Another alternative would be to have larger cutouts per section of where the camera is located so it can compensate for movement due to wind or other natural tendencies without compromising the clarity and use case of the car cover with your security system.

For the rear trunk, the rear part of the car cover could connect/tighten to the bumper with a larger clear apparatus to allow for wiggle room if it moves with the wind.

Optionally, the car cover could include magnetic means that allow for easy placement. For example, one portion could be permanently attached at critical locations that are visually hard to notice but allow for a reliable connection point to secure the car cover. For example, one could include magnets and/or ferromagnetic materials that are integrated into the cover and the windshield, even on the inside of the windshield. The car cover could also include a structural frame around the clear portion, such that the clear portion retains its position during wind and other natural tendencies.

Optionally, the car cover could include various features that could be opened without fully removing the car cover. For example, a zippered hatch could be integrated that allowed one to access the driver's door without taking the car cover off. The zippered hatch would have an overlapping strip of protective fabric on the inside that would prevent the mechanisms of the zipper from ever coming into direct contact with the car's exterior. This could also apply to the rear trunk and frunk as well to access it with the cover on.

The clear pieces of the car cover could also contain various ultraviolet (UV) coatings that prevented solar damage from occurring to the car's lenses underneath which would have led to a yellowing of the lenses, while also still allowing full functionality to the camera's viewing capabilities. If tint interfered with the clarity, one could simply coat the outside with ceramic coating to protect against elements of scratching, weather, or outside damage in any way to ensure clear viewing.

The car cover could also be devised to interact with the car's security system. If the cover was removed or partially removed it would trigger the car's built-in security to send a message to the owner. This can be achieved by sending a direct notification if the lock is being tampered with or unlocked. If a person or object gets within a certain distance of the vehicle, it will flash lights and send a push notification to the customer indicating to check the ‘live view’ to see if everything is okay and record any disturbances for further review post the incident. This means that the lock would include a battery and a wireless transmitter (i.e., WiFi, RF, Infrared, BlueTooth®) that would send a signal if it discovered it was tampered with.

The charge port will be attached using a hook-and-loop fastener (e.g., Velcro®) for easy access to charge the vehicle.

The security elastic hem and wheel fixing strap would connect to the car under the sides and wheelbase to further prevent someone from taking the cover off or wind blowing it away or off position. You could also connect a personal lock to this as well for added security if you see fit.

Material on the outside of the cover will protect from sun, UV rays, rain, dust, dirt, leaves, snow, frost, pollutants, bird droppings, etc. The cover will be perfect for indoor or outdoor use, which will allow it to stay clean and protected at all times.

Having this type of car cover on enables the car to be a theft deterrent, as sentry mode activates when the car detects someone approaching too closely. It continues working even when the vehicle is parked or turned off, which is a perfect way to protect the car more than just putting on a standard car cover. One can also Live Stream the car's live video footage to your phone via the app. One can also honk, flash headlights, or broadcast a voice message to the car's speakers. When a severe threat is detected, such as someone pushing on the car or breaking a window, Sentry Mode increases the brightness of the center display, activates the car alarm, and plays loud music.

It is contemplated that two versions will be able to be purchased; (1) Lock Guard—sewn into each lower side panel of the car cover are plastic grommets through which you can easily thread reinforced steel aircraft wire cable to run underneath the car; or (2) Gust Guard—which has an adjustable security cord with clamps that help hold the car and cover in place against the toughest weather conditions; and (3) both could be integrated into one car cover.

The upgraded versions of the car covers could also have bumper pads (i.e., protective panels) built on the inside of the rear and front bumper in case someone moves too close and hits the parked car. The bumper pads could also be disposed along the sides of the car cover, such that the bumper pads along the side doors prevent dents/scratches if an adjacent door is opened into the vehicle.

One can also upgrade the different types of materials used on the outside of the car cover based on the weather use case such as for sun, snow, debris, etc. The car cover could be customized fully with additional components integrated from hand-sewn or machine-sewn manufacturing techniques.

Additionally, the car cover can come with a convenient bag for storage. Alternatively, the car cover can itself turn into a portable bag when flipped inside out. For example, the inside of the car cover disposed about the rear can include a bag that is physically attached. This way the bag portion cannot be lost and the car cover can easily be folded into the bag when not in use and the car cover in the bag can be stored in the trunk or home of the owner.

Also, to keep the seams nice and tight where you don't have any rips, tears, or ability for water to seep into any cracks of the seams, we use a method of lock stitching that gives you two stitches on each seam and locks the material together.

The car cover of the present invention is shown and described in regard to Tesla® but it is not limited to any specific make or model of car and is also not limited to any particular car manufacturer and/or brand. Furthermore, the car cover of the present invention could even be used on a non-electric vehicle, understanding that not all of its functionality would be exploited. For example, the cover of the present invention could be used for EVs, hybrid vehicles, gas vehicles, trucks, motorcycles and/or aircraft.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a particular electric vehicle from an electric vehicle manufacturer;

FIG. 2 is another perspective view of the particular electric vehicle from the electric vehicle manufacturer of FIG. 1;

FIG. 3 is a perspective view similar to FIG. 1 now showing a prior art car cover;

FIG. 4 is a perspective view of the prior art car cover of FIG. 3 now shown from underneath with the vehicle removed;

FIG. 5 is a perspective view similar to FIG. 1 now showing an embodiment of the present invention car cover deployed on the vehicle;

FIG. 6 is another perspective view similar to FIG. 2 showing the present invention car cover of FIG. 5;

FIG. 7 is an enlarged view of the windshield camera area from FIG. 5;

FIG. 8 is a simplified sectional view of an embodiment of the car cover of the present invention showing in detail suction cups for enhanced attachment of the window about the windshield camera;

FIG. 9 is a simplified sectional view of another embodiment of the car cover of the present invention showing in detail magnets for enhanced attachment of the window about the windshield camera;

FIG. 10 is a simplified sectional view of another embodiment of the car cover of the present invention showing in detail hook-and-loop fasteners for enhanced attachment of the window about the windshield camera;

FIG. 11 is a simplified sectional view of another embodiment of the car cover of the present invention showing in detail button snaps for enhanced attachment of the window about the windshield camera;

FIG. 12 is an enlarged view showing the zipper of the present invention with a protective strip on the inside surface;

FIG. 13 is an enlarged view similar to that of FIG. 5 showing the charging port access flap in greater detail;

FIG. 14 is a simplified view of the present invention similar to FIG. 4 now showing a storage bag integrated into the car cover itself;

FIG. 15 illustrates an elastic strap or security strap that may be used with grommets of the present invention; and

FIG. 16 is a block diagram of a theft deterrent system of the present invention.

### DETAILED DESCRIPTION OF EMBODIMENTS OF THE INVENTION

The capability of Tesla's® “Sentry Mode” enables the cameras around the car to consistently monitor your vehicle and record any incidents of close proximity, vandalism, or accidents. When applying a standard car cover, all of the functionality of ‘Sentry Mode’ and the car's ability to monitor and keep it safe are completely gone. The car cover of the present invention will have clear openings (i.e., clear ABS/Acrylic/Polycarbonate/Glass) where each camera is located per the specific model and enable the car's safety capabilities even when completely covered. This will later apply to every vehicle that adopts/licenses Tesla's® camera technology for security and self-driving capabilities. Eventually, every vehicle manufacturer will adopt this type of technology, so it can be applied to all vehicles. Thus, the present invention is applicable to car beyond those made by Tesla®. Other manufacturers have comparable systems that the present invention can work with, such as Rivian's® “Gear Guard”, BMW's® “Drive Recorder”, Mercedes® “Urban Guard”, Lucid's® “DeamDrive Pro, and Hyundai's®/Kia's®/Genesis's® “Bluelink +SVM”.

The present invention is a state-of-the-art car cover design with the overall shape of each Tesla® Model (S, 3, X & Y) with all-in-one protection from the elements from wind, dirt, sun and water. The car cover will feature a covered cut-out where a clear apparatus will allow the onboard camera system to continue monitoring the vehicle. The apparatus may be coated with ceramic material so no water occludes the camera's ability to monitor. There may also be an opening (Velcro®/zipper) for the charger slot for easy access. A cut-out (zipper strip) where the driver's door is located for easy access. The front grill may have ventilated material so it can still breathe properly even if the vehicle is pre-heated, air-conditioned or biohazard mode is activated to clean the cabin air. Each tire location at the bottom of the car cover will have the ability to strap the car cover to the wheel's rim so it doesn't move or fly off. All front and rear taillights may be covered with the car cover but include perforations for light to shine through when alerting or scaring off intruders when the system picks up movement. Additionally, there may be reflectors around the vehicle to help with night driving for others to see the vehicle covered with the present invention.

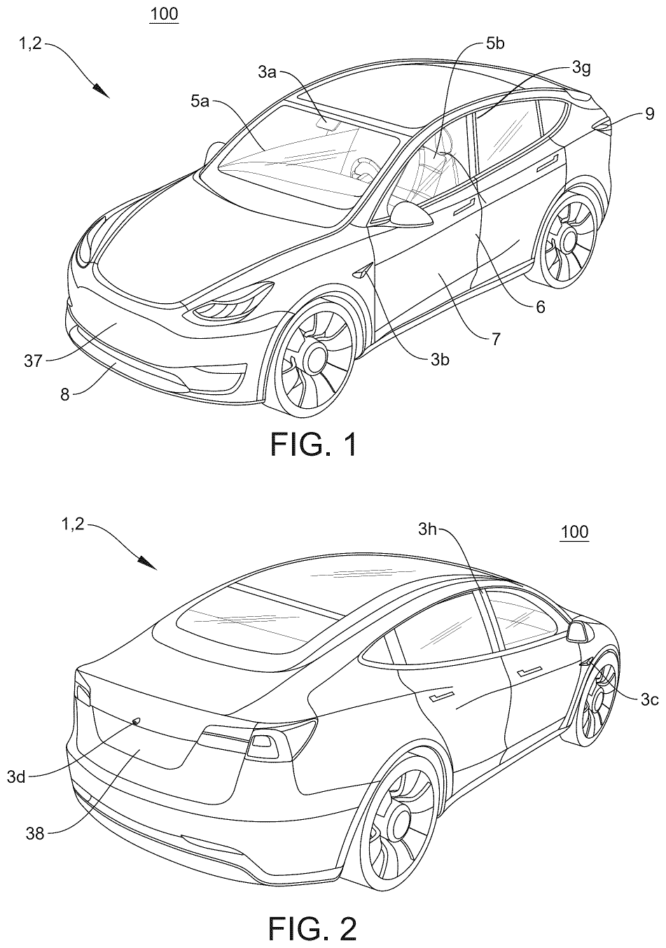

FIGS. 1 and 2 are perspective views of a particular electric vehicle 1 from an electric vehicle manufacturer 2. There are a multitude of video cameras 3 and/or sensors disposed around the vehicle. 3a is the front camera at the top of the windshield, 3b is the left rear facing camera behind the left front wheel, 3c is the right rear facing camera behind the right front wheel and 3d is a backup camera. 3g is a left-side camera along the left B pillar and 3h is a right-side camera along the right B pillar. These are just some examples of cameras that may be placed around the electric vehicle. More or less cameras can be used as these just exemplary of one vehicle embodiment. There may be a vent 8 that that allows air to come in and out of the vehicle. It would be preferable if the present invention did not interfere with this vent. The vehicle has at least one door 7 with a distal end 6 of the door that opens outwardly for a user to enter the vehicle. It would be preferable if the door could still be opened while not having the remove the entire car cover of the present invention. The vehicle has a charging port 9. Once again, it would be preferable if the car cover did not need to be removed for the charging port to be accessed. The vehicle has numerous windshields or windows 5. For example, the front windshield is 5a and a front side window is 5b. The camera at location 3a views through the front windshield 5a. It would be preferable if the car cover of the present invention did not interfere with this camera and others around the vehicle when the car cover was installed.

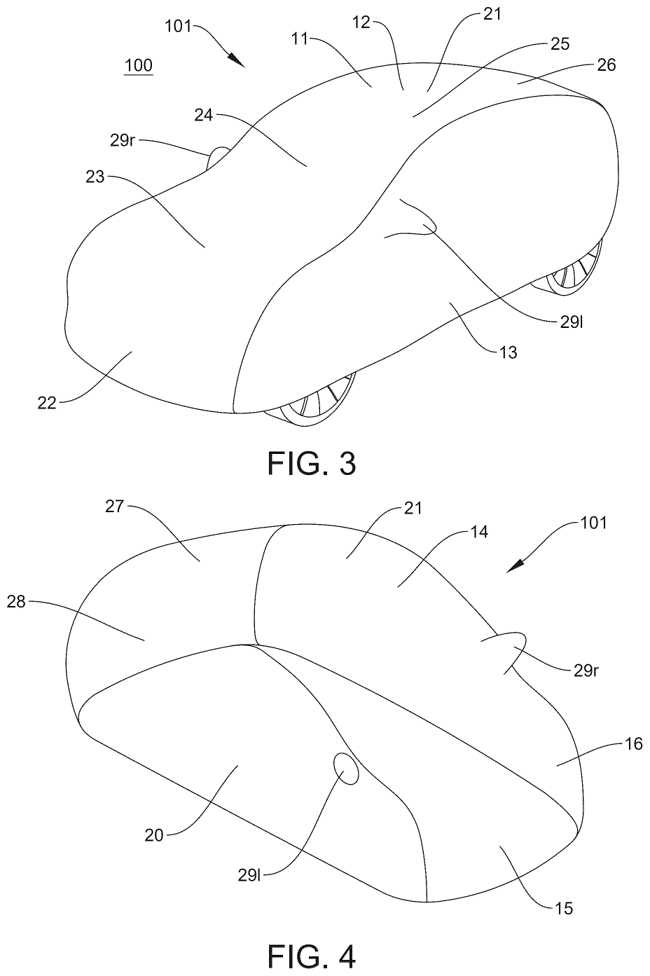

FIG. 3 is a perspective view similar to that of FIG. 1 now showing a prior art car cover 101 disposed over the vehicle. FIG. 4 is a perspective view from underneath the car cover 101 without the vehicle such that one can see inside the car cover. To better discuss the various features of the car cover of the present invention, the parts of the car cover are now further defined. The car cover has a cover material 11 that is configured to conformally fit over the particular electric vehicle model. Prior art car covers are not transparent and/or not clear. The cover material defines a top portion 12 connected to a left portion 13 and a right portion 14, wherein the top, left and right portions are configured to substantially cover the particular electric vehicle model while not substantially extending below the vehicle. The cover material defines an inside surface 20 that abuts the particular electric vehicle model and an outside surface 21 exposed to an outside environment 100. The top portion 12 further defines a front portion 22, the front portion adjacent to a hood portion 23, the hood portion adjacent to a front windshield portion 24, the front windshield portion adjacent to a roof portion 25, the roof portion adjacent to a rear windshield portion 26, the rear windshield portion adjacent to a trunk portion 27, the trunk portion adjacent to a rear portion 28. There are also side mirror pockets 29 formed in the car cover. More specifically, there is a left side mirror pocket 29l and a right-side mirror pocket 29r.

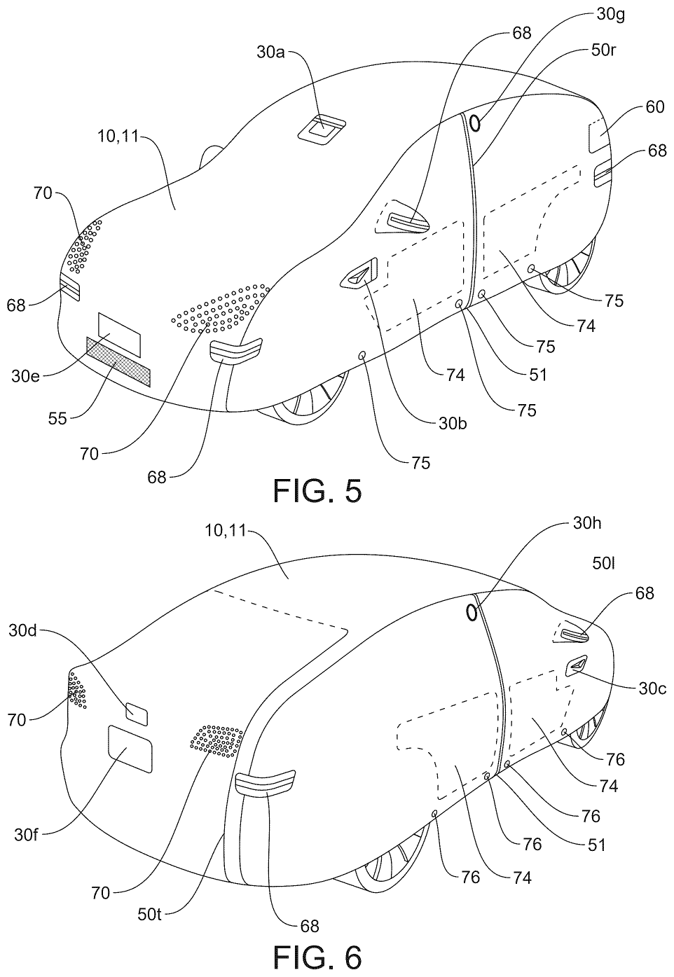

FIG. 5 is a perspective view similar to FIG. 1 now showing the car cover 10 of the present invention disposed over the vehicle. FIG. 6 is a perspective view similar to FIG. 2 now showing the car cover 10 of the present invention disposed over the vehicle. The car cover 10 includes at least one clear window 30 integrally formed within the cover. The at least one clear window is configured to be disposed over at least one video camera 3 of the particular electric vehicle model allowing the at least one video camera to view through the at least one clear window when the car cover is disposed over the particular electric vehicle model. More specifically, there is a window 30a over the camera 3a, a window 30b over the camera 3b, a window 30c over the camera 3c, a window 30d over the camera 3d, a window, a window 30g over the camera 3g and a window 30h over the camera 3h. It is understood by those skilled in the art that windows could be placed along any windshield, any pillar such as the A pillar or B pillar or any location along the cover material for any reason whether it is camera related or whether one wants to view the vehicle therebelow.

Window 30a can also be enlarged enough to allow viewing of a parking permit or window 30a can be moved to be disposed over the area of a parking permit. In this manner, the windows of the present invention can be used to allow cameras to view therethrough or be used to display indicia of the car protected underneath the car cover, such as parking permits, vehicle branding, license plates and the like.

The clear windows can also be used to display other graphical information on the vehicle. For example, window 30e can be used to be placed adjacent a front license plate location 37 and window 30f can be used to be placed adjacent a rear license plate location 38.

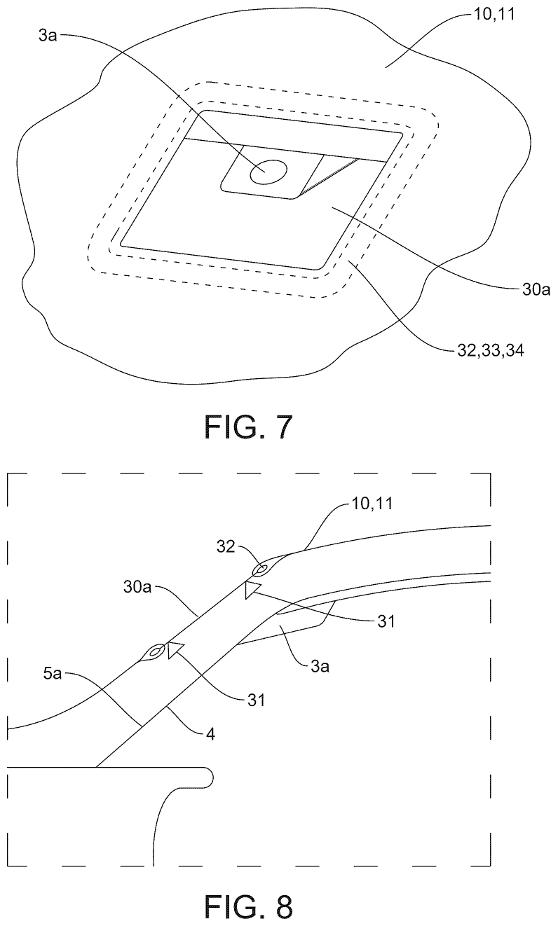

It is understood by those skilled in the art that properly aligning the windows with the various cameras is critical to ensure the cameras function properly when the car cover is deployed. To ensure this alignment, the present invention includes various additional improvements that facilitate this goal. For example, FIG. 7 is an enlarged view of the window 30a from FIG. 5. The window 30a may have a frame 32 disposed about the clear window, wherein the frame is more rigid in comparison to the cover material. The frame may go around the entirety of the window as shown here, or just a portion of the window. The frame may also be a separate part 33 attached about the at least one clear window. For example, the car cover material would be folded around the frame and the frame sewn into the car cover thus providing a more rigid perimeter structure. Alternatively, the frame may be comprised of a stiffer material 34 in comparison to the cover material. This could be accomplished by using a stiffer material around the frame portion or folding the material several times and sewing the folds in place. By providing a stiffer frame structure, the ability to align it to the various cameras is improved. This also then allows the window material itself, which may be a flexible or a hard clear polymer, to better allow light to pass therethrough undisturbed. Optionally, the window itself may be made from a stiff material such as polycarbonate such that the window is rigid enough to become the frame.

Now that the frame or the window itself can be more rigid, it is desired to locate it exactly to the cameras or locations on the vehicle itself. FIG. 8 is a simplified sectional view through the front windshield of the present invention. Here, the window, cover material and/or frame includes at least one suction cup 31 attached and disposed on the inside surface located at or near the clear window 3a.

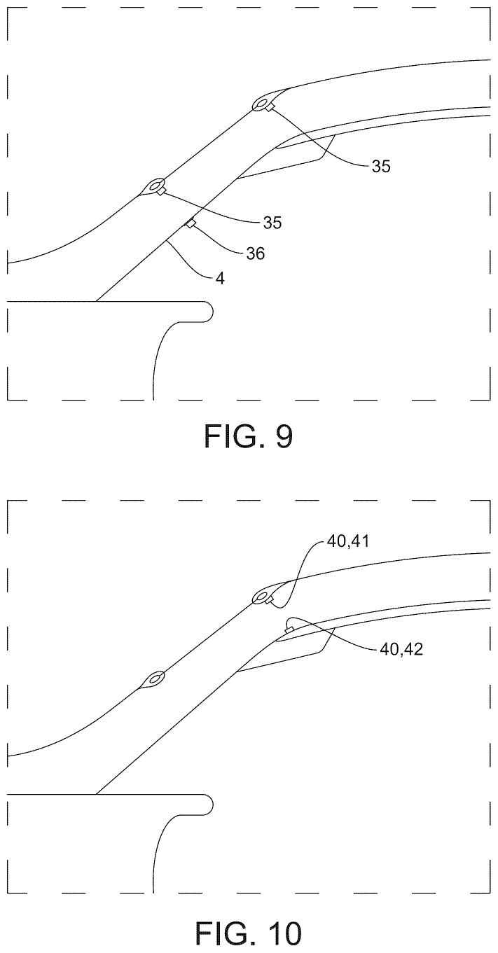

FIG. 9 is another embodiment now showing at least one first magnet 35 attached to the cover material disposed about the at least one clear window. At least one second magnet or ferromagnetic material 36 is configured to be attached to an inside surface 4 of the windshield or the window. The at least one second magnet or ferromagnetic material is configured to be aligned with the at least one first magnet when the car cover is disposed over the particular electric vehicle. The second magnet 36 can be a magnet can include an adhesive structure or backing, such that it can be adhered to the inside surface of the vehicle windshield. Alternatively, the magnet 35 can be attached directly to the metal of the vehicle body itself.

FIG. 10 is another embodiment now showing at least one hook-and-loop fastener 40 with a first side 41 of the at least one hook-and-loop fastener attached to the cover material disposed on the inside surface and located at or near the at least one clear window and a second side 42 of the at least one hook-and-loop fastener configured to be attached to the particular electric vehicle model near or about the at least one video camera. Such a hook-and-loop fastener is commonly referred to as Velcro®.

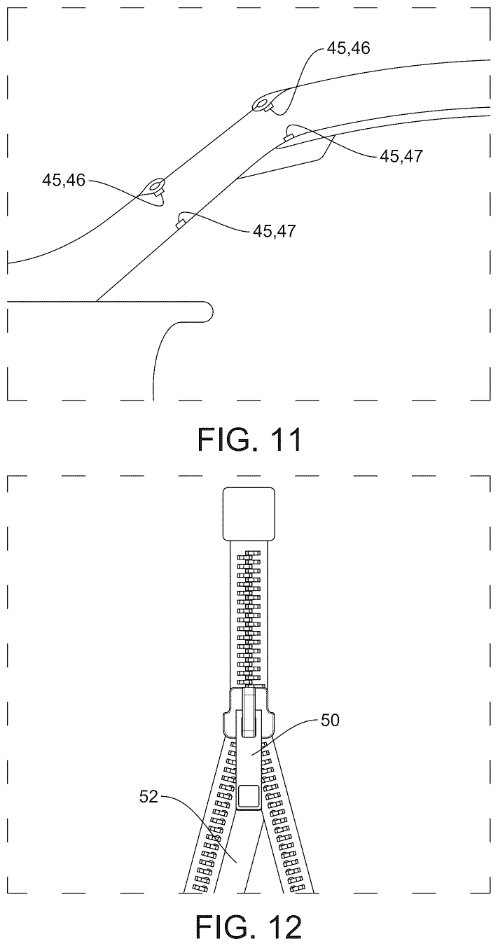

FIG. 11 is another embodiment now showing at least one snap button fastener 45 with a first side 46 of the at least one snap button fastener attached to the cover material disposed on the inside surface and located at or near the at least one clear window and a second side 47 of the at least one snap button fastener configured to be attached to the particular electric vehicle model near or about the at least one video camera. The second side 47 of the snap button fastener may include an adhesive backing or structure such that it can be adhered to the vehicle body or the windows or windshields. Due to the snap fastener being small in overall size, it could be attached directly to the outside of the windshield and result in very low viewing obstruction outwards by the occupants.

It is understood by those skilled in the art that the cover material may be a single layer. Alternatively, the cover material may also be a double layer with an outside layer 15 and an inside layer 16, where the outside layer is not the same as the inside layer.

Referring to FIGS. 3 and 4, the car cover may include a zipper 50 disposed on either the left portion or the right portion, where the zipper extends from the top portion to a bottom 51 of the left or the right portion, where the zipper opens starting from the bottom, and where the zipper is configured to be disposed at a distal end 6 of a door 7 of the particular electric vehicle model. As shown in the figures, there is a right-side zipper 51r and a left side zipper 51l. Also, there may be a zipper 50t disposed about the trunk of the vehicle. As shown in FIG. 12, which is a close-up view of the zipper 50, there may also be additional strip of protective material 52 disposed on the inside surface of the cover material overlapping the zipper. The additional strip of protective material 52 protects the paint and outside surface of the vehicle from the mechanisms of the zipper itself.

Referring to FIG. 5, the car cover may include at least one breathable mesh 55 integrally formed in the cover material configured to allow air to easily pass through, where the at least one breathable mesh is configured to be disposed adjacent to a vent 8 of the particular electric vehicle model.

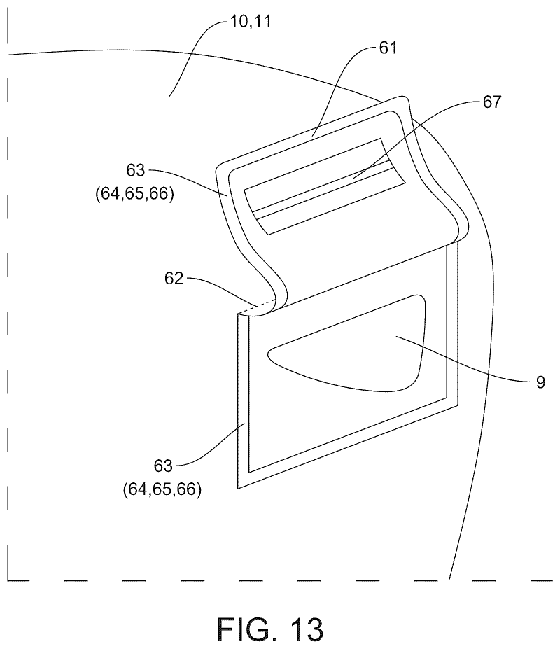

The car cover may also include a charging port access 60 integrally formed within the cover material, wherein the charging port access is configured to be disposed abutting the charging port 9 of the particular electric vehicle model. FIG. 13 is an enlarged view similar to that of FIG. 5 disposed about the charging port 9 but now shows the charging port access comprising an openable flap 61 formed in the cover material. The openable flap is flexibly connected at a top edge 62 and includes at least one openable side that includes a closure 63. The closure may be a zipper 64, a hook-and-loop fastener 65 or a snap button 66 as previously discussed herein. The openable flap may include at least one light reflective material 67 disposed on the inside surface of the openable flap, which may aid others seeing the charging port at night when the openable flap is opened.

Referring to FIGS. 5 and 6, the car cover may include at least one light reflection material 68 disposed on the outside surface of the cover material. As shown herein, there are several areas where reflective tape and/or reflective material may be integrated into the car cover, which aids others at night to view the location of the vehicle more easily.

The car cover may also include at least one perforated portion 70 configured to allow a portion of light to pass through, wherein the at least one perforated portion is configured to be disposed adjacent to a front headlight 71 or a rear taillight 72 of the particular electric vehicle model.

The car cover may include at least one protective panel 74 attached to the cover material. The protective panels may be sewn or integrated into the car cover material. The protective panels may be a semi-rigid foam or other equivalent structure that is configured to absorb impacts. The foam is configured to absorb door dings when adjacent vehicle doors are opened into the vehicle with the car cover deployed.

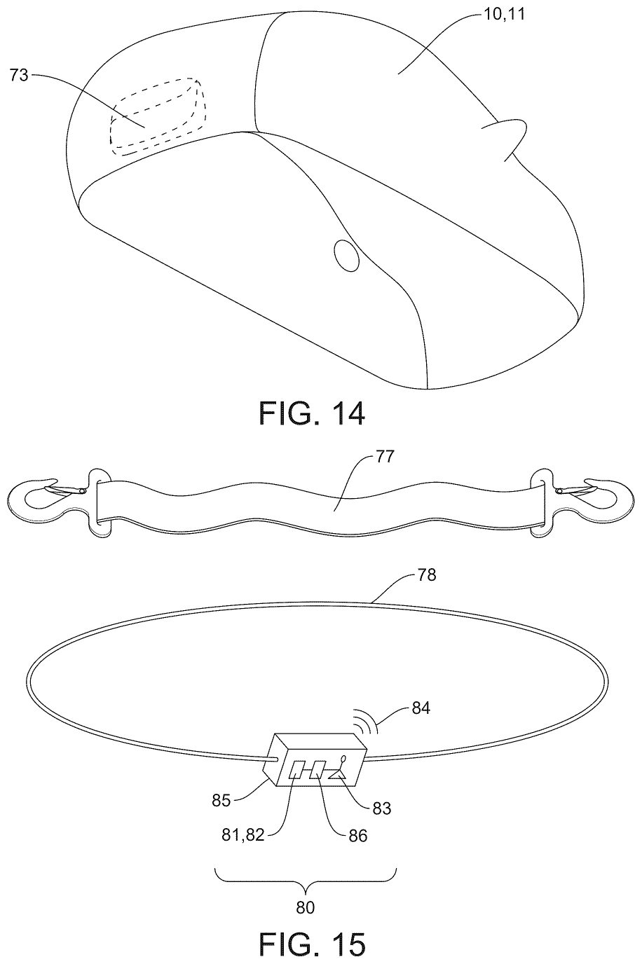

FIG. 14 shows that the car cover 10 may include a storage bag 73 configured to contain the car cover during storage, wherein the portable bag is integrally formed as part of the car cover. A good location would be at the back of the car cover disposed on the inside of the car cover. This location would not interfere with the rest of the car cover features disclosed herein and would itself be protected from the environment when deployed. The storage bag is shown in dashed lines because it is on the inside of the car cover.

As shown in FIGS. 5 and 6, the car cover may include at least one left grommet 75 disposed at a bottom of the left portions and at least one right grommet 76 disposed at a bottom of the right portion. The grommets are useful for attaching elastic straps or security straps to the underside of the vehicle. As shown in FIG. 15, at least one elastic strap 77 is configured to attach between the at least one left grommet and the at least one right grommet. This provides a secure method to keep the car cover in place when deployed in windy conditions.

Alternatively, the car cover may include at least one theft deterrent security cable 78 configured to attach between the at least one left grommet and the at least one right grommet. The security cable may be constructed of a metal or tamper resistant material. Furthermore, an electronic device 80 may comprise a power source 81 including a battery 82 configured to supply electrical energy to an electronic control unit 86. A wireless transmitter 83 may be operatively coupled to the power source, where the wireless transmitter configured to transmit a signal 84 wirelessly to the particular electric vehicle model if the cable 78 is tampered or broken. A housing 85 encloses the battery and the wireless transmitter, wherein the wireless transmitter is configured to transmit the signal when the at least one theft deterrent security cable has been tampered.

Additionally, a sensor-optimized optical clarity layer 30 may be disposed between the clear window and the outer shell, reducing glare, fogging, and optical distortion. This may include anti-fogging materials, UV inhibitors, or polarizing filters to ensure camera clarity across various weather conditions. A car cover of claim 1, wherein the clear window includes an optical clarity layer configured to reduce distortion and maintain sensor visibility during adverse conditions.

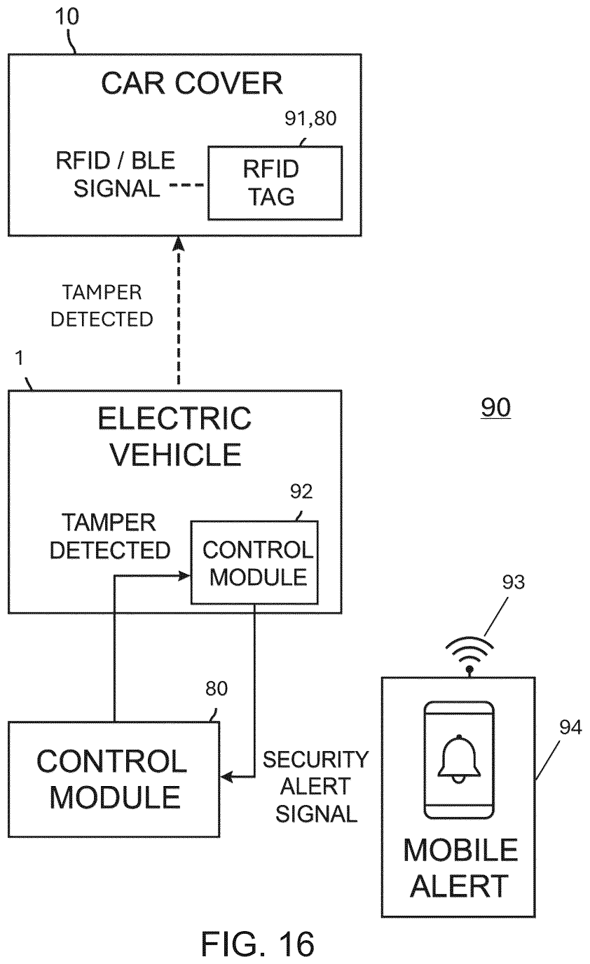

FIG. 16 is a block diagram of a theft deterrent system 90 that can be further configured in the present invention. Optionally, the car cover may include embedded RFID tags, NFC tags, or BLE (Bluetooth Low Energy) sensors 91. These components are configured to transmit vehicle-specific information, such as a unique ID signal, which can be received by the vehicle's onboard system or a user's mobile application. These tags and sensors can be powered or sensed by the vehicle itself or include their own power source 80 as previously discussed. Upon detection, the car cover can automatically associate with the vehicle, authorize access, trigger unlocking of magnetic fasteners, or initiate security monitoring. The control module 92 of the vehicle can then send a signal 93 to a mobile device 94, or the mobile device 80 of the present invention can send the signal 93 to the mobile device 94.

The cover material of the present invention can also include shear- thickening fluids and/or other impact-resistant foams to protect from hail and physical damage such as D30®, Dow Corning® impact materials and/or Rheon™ Labs materials.

As another option, portions of the cover material can include inflatable air-bladder layers inflated via a built-in air pump.

Transparent and clear are often used interchangeably, but they have slightly different meanings. Transparent refers to the property of allowing light to pass through a material, possibly with some scattering, while clear indicates a uniform index of refraction and no scattering of light. In common usage, both terms can mean “see through,” but clear can also imply the absence of cloudiness, haziness, or muddiness. Thus, the present invention utilizes windows with clear portions (i.e., optically clear) that do not interfere with the vehicle's camera systems and provide no interference to the light or energy being transmitted therethrough.

Although several embodiments have been described in detail for purposes of illustration, various modifications may be made to each without departing from the scope and spirit of the invention. Accordingly, the invention is not to be limited, except as by the appended claims.

### Numerals

1 particular electric vehicle model
2 electric vehicle manufacturer
3 at least one video camera, vehicle
4 inside surface, windshield or window, vehicle
5 windshield or window, vehicle
6 distal end, door, vehicle
7 door, vehicle
8 vent, vehicle
9 charging port, vehicle
10 car cover, present invention
11 cover material
12 top portion
13 left portion
14 right portion
15 outside layer, car cover
16 inside layer, car cover
20 inside surface
21 outside surface
22 front portion
23 hood portion
24 front windshield portion
25 roof portion
26 rear windshield portion
27 trunk portion
28 rear portion
29 side mirror pocket
30 at least one clear window
31 at least one suction cup
32 frame
33 separate part, frame
34 stiffer material, frame
35 at least one first magnet
36 at least one second magnet or ferromagnetic material
37 front license plate location
38 rear license plate location
40 at least one hook-and-loop fastener
41 first side, at least one hook-and-loop fastener
42 second side, at least one hook-and-loop fastener
45 at least one snap button fastener
46 first side, at least one snap button fastener
47 second side, at least one snap button fastener
50 zipper
51 bottom, zipper
52 protective material
55 at least one breathable mesh
60 charging port access
61 openable flap
62 top edge, openable flap
63 closure, openable flap
64 zipper, openable flap
65 hook-and-loop fastener, openable flap
66 snap button, openable flap
67 at least one light reflective material, openable flap
68 at least one light reflection material, car cover
70 at least one perforated portion
71 front headlight, vehicle
72 rear taillight, vehicle
73 storage bag
74 protective panel
75 at least one left grommet
76 at least one right grommet
77 at least one elastic strap
78 at least one theft deterrent security cable
80 electronic device
81 power source
82 battery
83 wireless transmitter
84 signal
85 housing
86 electronic control unit (ECU)
90 theft deterrent system
91 RFID tag, NFC tags, or BLE sensor
92 control module, particular electric vehicle model
93 signal
94 mobile device
100 outside environment
101 car cover, prior art

What is claimed is:

1. A car cover, comprising:
a cover material configured to conformally fit over a particular electric vehicle model from an electric vehicle manufacturer, the cover material defining a top portion connected to a left portion and a right portion, wherein the top, left and right portions are configured to substantially cover the particular electric vehicle model while not substantially extending below the vehicle;
wherein the cover material defines an inside surface that abuts the particular electric vehicle model and an outside surface exposed to an outside environment;
wherein the top portion further defines a front portion, the front portion adjacent to a hood portion, the hood portion adjacent to a front windshield portion, the front windshield portion adjacent to a roof portion, the roof portion adjacent to a rear windshield portion, the rear windshield portion adjacent to a trunk portion, the trunk portion adjacent to a rear portion;
wherein the cover material is not transparent or not clear; and
at least one clear window integrally formed within the cover material, wherein the at least one clear window is configured to be disposed over at least one video camera of the particular electric vehicle model allowing the at least one video camera to view through the at least one clear window when the car cover is disposed over the particular electric vehicle model so as to maintain optical clarity, minimize distortion, or ensure continued operation of the at least one video camera.

2. The car cover of claim 1, including at least one suction cup attached to the cover material disposed on the inside surface and located at or near the at least one clear window.

3. The car cover of claim 1, including a frame disposed about the at least one clear window, wherein the frame is more rigid in comparison to the cover material.

4. The car cover of claim 1, wherein the frame is a separate part attached about the at least one clear window.

5. The car cover of claim 1, wherein the frame is comprised of a stiffer material in comparison to the cover material.

6. The car cover of claim 1, including at least one first magnet attached to the cover material disposed about the at least one clear window.

7. The car cover of claim 6, including at least one second magnet or ferromagnetic material configured to be attached to an inside surface of a windshield or a window of the particular electric vehicle model, wherein the at least one second magnet or ferromagnetic material is configured to be aligned with the at least one first magnet when the car cover is disposed over the particular electric vehicle.

8. The car cover of claim 1, including at least one hook-and-loop fastener with a first side of the at least one hook-and-loop fastener attached to the cover material disposed on the inside surface and located at or near the at least one clear window and a second side of the at least one hook-and-loop fastener configured to be attached to the particular electric vehicle model near or about the at least one video camera.

9. The car cover of claim 1, including at least one snap button fastener with a first side of the at least one snap button fastener attached to the cover material disposed on the inside surface and located at or near the at least one clear window and a second side of the at least one snap button fastener configured to be attached to the particular electric vehicle model near or about the at least one video camera.

10. The car cover of claim 1, wherein the cover material is a single layer.

11. The car cover of claim 1, wherein the cover material is a double layer with an outside layer and an inside layer, where the outside layer is not the same as the inside layer.

12. The car cover of claim 1, including a zipper disposed on either the left portion or the right portion, where the zipper extends from the top portion to a bottom of the left or the right portion, where the zipper opens starting from the bottom, and where the zipper is configured to be disposed at a distal end of a door of the particular electric vehicle model.

13. The car cover of claim 12, including an additional strip of protective material disposed on the inside surface of the cover material overlapping the zipper.

14. The car cover of claim 1, including at least one breathable mesh integrally formed in the cover material configured to allow air to easily path through, where the at least one breathable mesh is configured to be disposed adjacent to a vent of the particular electric vehicle model.

15. The car cover of claim 1, including a charging port access integrally formed within the cover material, wherein the charging port access is configured to be disposed abutting a charging port of the particular electric vehicle model.

16. The car cover of claim 15, wherein the charging port access comprises an openable flap formed in the cover material.

17. The car cover of claim 16, wherein the openable flap is flexibly connected at a top edge and includes at least one openable side that includes a closure, the closure comprising a zipper, a hook-and-loop fastener or a snap button.

18. The car cover of claim 1, including at least one light reflective material disposed on the inside surface of the openable flap.

19. The car cover of claim 1, including at least one light reflection material disposed on the outside surface of the cover material.

20. The car cover of claim 1, including at least one perforated portion configured to allow a portion of light to pass through, wherein the at least one perforated portion is configured to be disposed adjacent to a front headlight or a rear taillight of the particular electric vehicle model.

21. The car cover of claim 1, including a storage bag configured to contain the car cover during storage, wherein the portable bag is integrally formed as part of the car cover.

22. The car cover of claim 1, including at least one protective panel attached to the cover material.

23. The car cover of claim 1, including at least one left grommet disposed at a bottom of the left portions and at least one right grommet disposed at a bottom of the right portion.

24. The car cover of claim 23, including at least one elastic strap configured to attach between the at least one left grommet and the at least one right grommet.

25. The car cover of claim 23, including at least one theft deterrent security cable configured to attach between the at least one left grommet and the at least one right grommet.

26. The car cover of claim 25, including an electronic device comprising: a power source including a battery configured to supply electrical energy to an electronic control unit; a wireless transmitter operatively coupled to the power source, the wireless transmitter configured to transmit a signal wirelessly to the particular electric vehicle model; and a housing enclosing the battery and the wireless transmitter, wherein the wireless transmitter is configured to transmit the signal when the at least one theft deterrent security cable has been tampered.

27. The car cover of claim 1, including at least one embedded RFID tag or wireless transmitter configured to communicate a unique identification signal to the particular electric vehicle model.

28. The car cover of claim 27, wherein the particular electric vehicle model is configured to automatically recognize the RFID tag and initiate vehicle-specific functions.

29. The car cover of claim 1, wherein the at least one clear window includes an optical clarity layer configured to reduce distortion and maintain sensor visibility during adverse conditions.

30. The car cover of claim 1, including a wireless module configured to transmit a tamper or security alert if the car cover is disturbed while deployed.

31. A car cover, comprising:
a cover material configured to conformally fit over a particular electric vehicle model from an electric vehicle manufacturer, the cover material defining a top portion connected to a left portion and a right portion, wherein the top, left and right portions are configured to substantially cover the particular electric vehicle model while not substantially extending below the vehicle;
wherein the cover material defines an inside surface that abuts the particular electric vehicle model and an outside surface exposed to an outside environment;
wherein the top portion further defines a front portion, the front portion adjacent to a hood portion, the hood portion adjacent to a front windshield portion, the front windshield portion adjacent to a roof portion, the roof portion adjacent to a rear windshield portion, the rear windshield portion adjacent to a trunk portion, the trunk portion adjacent to a rear portion;
wherein the cover material is not transparent or not clear;
at least one clear window integrally formed within the cover, wherein the at least one clear window is configured to be disposed over at least one video camera of the particular electric vehicle model allowing the at least one video camera to view through the at least one clear window when the car cover is disposed over the particular electric vehicle model;
at least one zipper disposed on either the left portion or the right portion, where the at least one zipper extends from the top portion to a bottom of the left or the right portion, where the at least one zipper opens starting from the bottom, and where the at least one zipper is configured to be disposed at a distal end of a door of the particular electric vehicle model, and including an additional strip of protective material disposed on the inside surface of the cover material overlapping the at least one zipper;
at least one breathable mesh integrally formed in the cover material configured to allow air to easily path through, where the at least one breathable mesh is configured to be disposed adjacent to a vent of the particular electric vehicle model; and
a charging port access integrally formed within the cover material, wherein the charging port access is configured to be disposed abutting a charging port of the particular electric vehicle model, wherein the charging port access comprises an openable flap formed in the cover material.

32. A car cover, comprising:
a cover material configured to conformally fit over a particular vehicle model from a vehicle manufacturer, the cover material defining a top portion connected to a left portion and a right portion, wherein the top, left and right portions are configured to substantially cover the particular vehicle model while not substantially extending below the vehicle;
wherein the cover material defines an inside surface that abuts the particular vehicle model and an outside surface exposed to an outside environment;
wherein the top portion further defines a front portion, the front portion adjacent to a hood portion, the hood portion adjacent to a front windshield portion, the front windshield portion adjacent to a roof portion, the roof portion adjacent to a rear windshield portion, the rear windshield portion adjacent to a trunk portion, the trunk portion adjacent to a rear portion;
wherein the cover material is not transparent or not clear; and
at least one clear window integrally formed within the cover, wherein the at least one clear window is configured to be disposed over at least one video camera of the particular vehicle model allowing the at least one video camera to view through the at least one clear window when the car cover is disposed over the particular vehicle model.
